(19) United States
(12) Patent Application Publication
(10) Pub. No.: US 2006/0084381 A1
(43) Pub. Date: Apr. 20, 2006

(54) Method for establishing a connection between a mobile device and a second device

(76) Inventor: Stephan Hartwig, Essen (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/519,669

(22) PCT Filed: Jul. 1, 2002
(86) PCT No.: PCT/IB02/02519

§ 371 Date: Sep. 22, 2005

(51) Int. Cl. H04Q 7/20

(52) U.S. Cl. 455/41.2; 455/456.3

(57) ABSTRACT

The present invention relates to a method for establishing a connection from a mobile device (10) to a second device (20) both provided with a short range wireless communications module (11, 21). To reduce the set-up time for establishing such a connection significantly the method according to the present invention comprises the steps of: determining the present environment of the mobile device (10), determining an address (DAC) of the second device in dependence on the present environment of the mobile device (1), and setting up the connection to the second device (2) using the address (DAC) determined in the previous step.

The present invention relates to a method for establishing a connection between a mobile device and a second device both provided with a short range wireless communications module.

For connecting mobile electronic devices, like mobile telephones, car telephones, portable computers (laptop), handheld computers and the like with other mobile or stationary electronic devices different wireless communications technologies are used. For example infrared technology is used for connecting mobile phones and handheld computers with each other.

For wireless networking low power radio communications technologies have been developed like Apple-AirPort and Bluetooth.

For setting up a connection between two devices the calling or source device has to know the device access code or address of the destination or device to be called. Therefore, in case that an electronic device including a short range radio communications module, in particular a Bluetooth module, has to set-up a connection to another electronic device the device access code or address of which is not known to the calling device, the source or calling device has to discover which devices are in range and what their device addresses are by means of an inquiry procedure. Thereafter, a desired destination or device to be called can be paged directly using the device access code of this device for setting up the connection.

Since in an inquiry state the calling or source device has to broadcast a general or dedicated inquiry access code at different hopping frequencies whereas the destination devices have to scan for an inquiry access code for a certain time at the different hopping frequencies, the inquiry procedure to acquire the destination's device address takes a rather long time. In particular, connection set-up times of about 10 seconds are expected in real-live environments. However, this is unacceptable for a user for practical use.

Such set-up time adds an unacceptable latency to the connection establishment. For example a low-value credit card transaction takes an average of 10 seconds, cash transactions only needs three seconds and automatic toll collection needs only one second.

### SUMMARY OF THE INVENTION

The object of the present invention is to provide an improved method of establishing a connection between two electronic devices, in particular between a mobile device and a second device that reduces the set-up time for establishing the connection significantly.

This object is achieved by the method according to claim 1. Advantageous developments and refinements of the present invention are described in the depending claims.

For establishing a connection from a connecting mobile device to a second device the present environment of the mobile device is determined for determining the address of the stationary device in dependence on the present environment of the mobile device. Then, the connection to the second device is set up using the address determined in the previous step. In this way it is possible to reduce the set-up time significantly, since the lengthy inquiry procedure can be skipped if the device address is known in advance so that the procedure for setting up the connection can be performed directly.

In particular, if a user is initiating a device search, a choice of potentially connectable devices can be displayed immediately to the user. A simultaneous inquiry and name discovery can optionally be used to dynamically correct and extend the displayed choice of connectable devices. The user can immediately try to connect to a selected device and thus reduce the setup time, which usually includes the time consuming inquiry and name discovery procedure. In case the current environment cannot be related to any device just the usual device discovery is performed.

Thus, according to a preferred refinement of the present invention a step of discovering which devices are available and what their addresses are is performed in parallel with determining the address of the stationary device in dependence on the present environment, and setting up the connection to the second device upon selecting it by a user using the address discovered in the discovering step.

Preferably, the second device is paged for setting up the connection by means of the short range wireless communications module of the mobile device using the address determined in dependence on the present environment of the mobile device.

According to another advantageous refinement of the present invention the address of the second device is determined by comparing environment data according to the present environment of the mobile device with environment data of devices stored in a memory of the mobile device together with the device address, wherein the environment data and the device address of a second device were stored when the mobile device was connected to the second device one or more times in the past.

In order to create an internal list of devices which are available in certain enviroments it is possible that the environment data of the mobile device being connected to a second device is stored as environment data of the second device. The environment information stored for the address of a particular device can be improved during each connect to this device. For this purpose the environment data of the second device to be stored in the mobile device can be transmitted from the second device to the mobile device. In this case it is possible to obtain more accurate position data of the stationary device.

According to another advantageous refinement of the present invention the environment data and the device address of a certain second device are transmitted and stored independently from a connection between the mobile device and the second device. The list of devices and their corresponding positions can, for example, be downloaded from a server.

To make it possible to connect a mobile device without a previous device discovery to a second device, upon selecting a connect function an advantageous refinement of the present invention is chracterized in that in case that only one device address is stored together with environment data corresponding to the present environment of the mobile device a connection to this device is set up automatically. If this fails, because the device is not available, the user interface notifies the user accordingly and/or starts device search and displays a list of truly available devices.

In addition, the mobile device can use the stored information to automatically connect to a connectable device without user interaction, e.g. when passing a toll station, if a connection to this device is set up automatically in case that one device address that is stored together with environment data corresponding to the present environment of the mobile device is marked as to be automatically connected to.

In case that more than one device addresses are stored together with environment data corresponding to the present environment of the mobile device, a list of those devices is output to the user for selecting that stationary device that the user wants the mobile device to be connected to by the wireless communications module. Here it is prefered that the devices are identified in a name format in the list output to the user.

According to another development of the present invention it is provided that the present environment of the mobile device is determined by means of the present position of the mobile device. For determining the present position of the mobile device different methods can be used. However, according to a first development of the invention the present position of the mobile device is obtained by determining the position of the mobile device in a cellular radio communications network. This method, that e.g. evaluates the signals from one or more base stations, is of advantage in case that the mobile device is a mobile telephone or any other communications device using a cellular network.

According to a preferred embodiment of the present invention the current position of the mobile device is obtained by determining the position of the mobile device by means of a satellites based positioning system, in particular by means of the global positioning system.

Further, it is possible that the address of the second device that is a stationary device, is determined by calculating the device address from the position data using a predefined deterministic function.

This embodiment makes it possible to reduce the set-up time even for the first time connect to a stationary device or server. However, this embodiment of the invention requires a small addition to the corresponding communication standard. If a subrange of the device address space would be reserved for stationary devices, it is possible to predefine a deterministic function which can be used to calculate the device address from the position data or at least to reduce the number of candidate addresses that come into question.

A further improvement of this invention is characterized in that in the present environment of the mobile device is determined by means of the current user context.

According to this improvement the position or location of the mobile device is considered to be only one parameter for determining the environment of the mobile device according to the current user context. Other parameters of user context sensed by the mobile device can include, but are not restricted to, the users identity, the time of day and how many times the user connected to a specific device, e.g. a stationary device in the past. The mobile device decides to add a device into the internal list of stored devices (or prompts the user to do so), when an internal algorithm discovers a sufficient match between user context data, which were sensed during each instance the user connected to a particular device. This algorithm would typically employ pattern recognition techniques. The address of the device is stored with corresponding parameters derived from the context data sensed. The averaged position of the mobile device can be one of these parameters.

A device is considered to be a potential connectable device, if the current user context matches the parameters of a stored address according to a confidence criterion.

The advantage of this procedure is that not only a stationary device but also a non-stationary device can, for example, be found to be a potential connectable device when it is always used at the same time of day, even though it changes locations like a device located in a vehicle used by its owner often at the same time of the day.

### BRIEF DESCRIPTION OF THE DRAWINGS

The present invention will be described in more detail with reference to a preferred embodiment illustrated in the accompanying drawings.

FIG. 1 shows a simplified schematic block diagram of a mobile device and a stationary device; and

FIG. 2 is a simplified flow chart of the inventive method.

### DETAILED DESCRIPTION OF PREFERRED EMBODIMENTS OF THE INVENTION

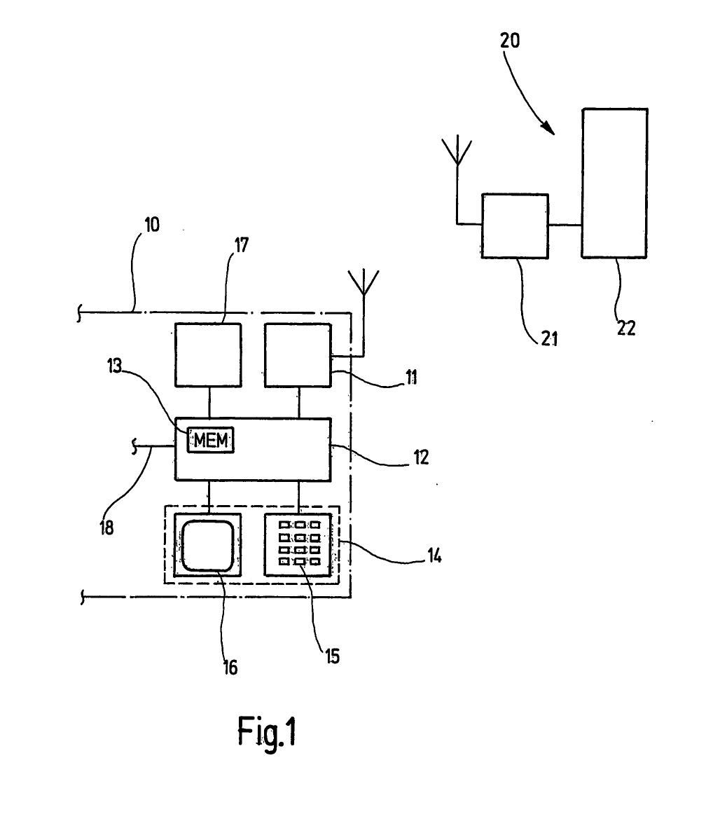

As shown in FIG. 1 a mobile device 10, e.g. a mobile telephone, comprises a short range wireless communications module 11, e.g. a low power radio frequency communications module that operates in accordance with the Bluetooth standard. The short range wireless communications module, that is called in the following description Bluetooth module 11, is connected to a central processing unit 12 that is controlling all activities of the mobile device 10. The central processing unit 12 comprises a memory (MEM) 13 for storing device address data together with enviroment data, in particular with position data. These devices are assumed to be potentially connectable devices, because they should be close enough to be connected by the mobile device 10, if the mobile device is in the same environment, in particular at the same location where these devices are supposed to be.

A user interface 14 for controlling the mobile device 10 comprises a keypad 15 and a display 16. However, other and/or additional input means like turn-push buttons, Jog-dials or the like as well as voice input means can be provided, too. Further, a loudspeaker can be used for outputting information to the user instead or preferably in addition to the display 16.

Further, a positioning module 17 is provided to determine the current position of the mobile device. The positioning module can be formed, e.g. by a GPS module or by any other positioning module. In particular, it is also possible to use positioning information of a cellular radio telecommunications network to determine the actual position of the mobile device 10 in the positioning module 17.

Output 18 of the central processing unit 12 indicates connections to other modules of the mobile device like SIM card, wide range transceiver for use in a cellular radio communications network and the like.

A second device located in a certain environment, e.g. a stationary device 20 comprises a short range wireless communications module 21 that is able to communicate with that of the mobile device 10. Consequently, for ease of description the short range wireless communications module of the stationary device will be called Bluetooth module 21 in the following description without restricting the present invention to this standard.

The Bluetooth module 21 of the stationary device 20 is connected to a stationary server 22 that can be for example a payment device at a till, an automatic toll collection device, a vending machine, a point-of-interest server and any other kind of stationary servers.

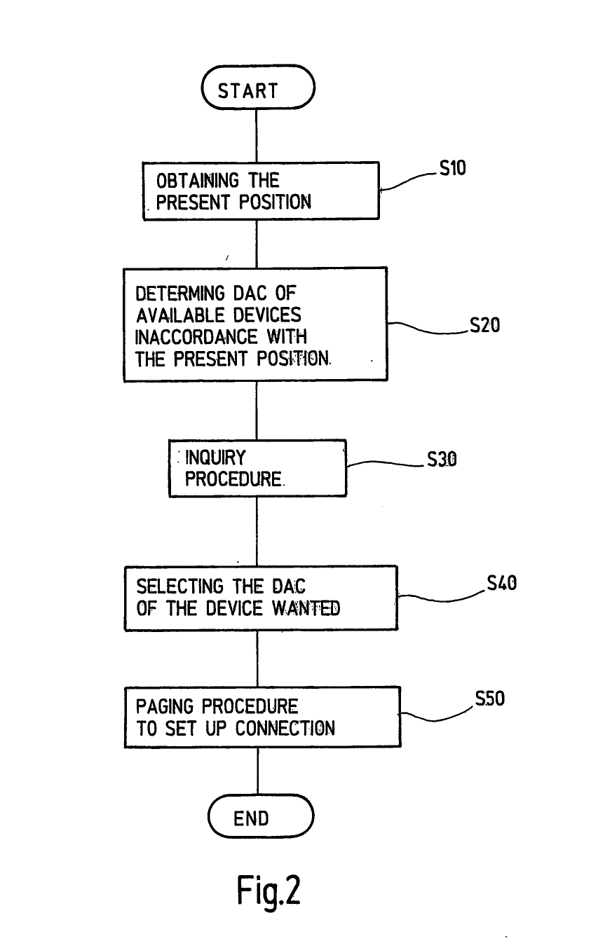

If a user of a mobile device 10 adapted to work in accordance with the present invention wants the mobile device to be connected to a stationary device 20, e.g. a vending machine or a point-of-interest information server by means of the Bluetooth module 21, the mobile device 10 first obtains its current position from the positioning module 17 in step S10 as shown in FIG. 2. Then, it checks whether or not a device address, i.e. the address of the vending machine or the point-of-interest information server is stored together with the actual position of the mobile device 10 in step S20 for determining addresses DAC of devices in accordance with the current position of the mobile device. If there is a device address stored together with the current position or with a position closely related with the current position this address is assumed to be the device address of the stationary device 20 in question.

Since positioning data for one and the same location might differ from time to time due to tolerances it is of advantage to regard stored position data as equal to current position data if the difference between the stored data and the actual data is less than a predefined threshold value.

If only one address DAC of one stationary device was successfully determined in step S20 this address can be used for directly paging the stationary device in step S50 if no selection procedure is required in step S40.

However, if no device address is stored in the mobile device, i.e. that it is the first time that the mobile device 10 should be connected to a specific stationary device 20, then the Bluetooth module 11 has to perform the usual procedure for establishing a connection, i.e. to perform an inquiry procedure to discover which units or devices are in range and what their device addresses and clocks are in step S30. Thereafter, the paging procedure for establishing an actual connection is performed in steps S40 and S50.

Although it is possible that the steps S20 and S30 are performed successively, it is preferred that these steps are carried out simultaneously. Therefore, if a user of a mobile device wants his/her device to be connected to a device she/he activates a search mode. There upon it is detected in the mobile device 10 that there are stationary devices 20 stored in a respective memory 13 so that these devices can be immediately displayed to the user in a manner that indicates that these devices are potentially connectable devices. Simultaneously the usual inquiry procedure is started and other devices found are displayed in the same display one by one in a manner indicating that these devices are available. If one of the potentially connectable devices are actually found by inquiry their display style is changed to indicate that these devices are connectable devices actually available.

In case that the mobile device 10 has to be connected to a specific stationary device 20 at the first time, the user can be prompted for deciding whether the current position data and address of the actual stationary device 20 should be stored or not. Alternatively, the mobile device 10 may assume by default that every device is stationary and only if this assumption is observed to be false in subsequent connection attempts, such device are removed.

Instead of using the position of the mobile device 10 determined by the positioning module 17 for storing it together with the device address of the stationary device 20 it is also possible to transmit position data from the stationary device 20 to the mobile device 10 so that positioning data of higher accuracy can be used in future for determining the device address of the stationary device 20.

In case that more than one stationary device 20 provided with a corresponding Bluetooth module 21 exist at the current position of the mobile device 10 so that it is not clear to the mobile device 10 to which of the stationary devices 20 a connection is needed, a selecting procedure is performed in step S40, i.e. the user is asked to select one of the available stationary devices 20. To assist the user in selecting a device wanted a choice of potentially connectable devices, i.e. a list of such devices is output to him/her which preferably identifies the potentially available stationary devices 20 in a user friendly name format.

After selecting the desired device, i.e. after deciding which device address code DAC have to be used, the paging procedure to set-up the desired connection is performed in the usual way in step S50.

For determining a device address in step S20 it is also possible to calculate a device address from the current position data by means of a deterministic function if such a possibility is provided in the communications standard used.

According to the present invention it is also possible to transmit the address and location information to the mobile device 10, without knowing or connecting the stationary devices 20 in advance. In case, that a user having a mobile device 10 adapted according to the present invention visits an exhibition consisting of different pavilions, some or each of which have/has stationary devices 20 adapted according to the present invention attached to them for informing visitors (so called Bluetooth information kiosks), it is possible that upon entering the exhibition premises, the user downloads a list of device addresses together with their location information. An application in the mobile device 10, e.g. a mobile phone, constantly monitors the user's position and once he/she comes close to a pavillion it automatically starts paging for the corresponding info kiosk and—if found—displays the info page of this pavillion (probably the user's device beeps and displays a message “display german pavillion page?” where the user has to “accept” or “cancel”). In this case, the position data and the device address DAC of the stationary device 20 are transmitted and stored independently from a connection between the mobile device 10 and the stationary device 20.

In addition it is possible that the mobile device 10 constantly pages for potentially connectable devices in the background to verify whether they are actually connectable and thus improve the initial list of devices displayed to a user whenever initiating a device search. The advantage of this procedure is that the Bluetooth module 11 is only active, while potentially connectable devices are supposed to be in proximity of the mobile device 10. Consequently, this procedure consumes much less power than a permanent inquiry procedure running in background all the time.

Furthermore, in order to create an internal list of devices which are available in certain enviroments, a decision has to be made either by the mobile device 10 or by the user whether the address and environment data of a second device shall be stored in the memory of the mobile device 10. The user can decide to store the environment and address data of a second device 20 together with some attributes, like device name, link key and the like. This can be a menu option or context sensitive dialog displayed by the mobile device 10, preferably in timely context of a connection to the second device 20.

The mobile device can decide to automatically store the environment and address data together with some attributes, depending on several confidence criteria. These criteria can include the number of instances, the user connected to this device in the past and the deviation of measured location of this device in each of these instances. Further, depending on confidence criteria a context sensitive dialog is displayed or not to the user on whether the storage of the device is desired.

Although, the present invention has been describe mainly in connection with stationary devices, i.e. devices that does not change its location, wherein position data are used to determine the environment of these devices, the present invention is not restricted thereto. In particular it is possible to determine the environment of a second device form other parameters of a user's context like the users name, time of the day, the number connections to a certain device at a certain time of the day and the like.

1. A method for establishing a connection from a mobile device (10) to a second device (20) both provided with a short range wireless communications module (11, 21), comprising the steps of:
determining a present environment of the mobile device (10) determined by means of a present position of the mobile device (10),
determining an address (DAC) of the second device in dependence on said present environment of the mobile device (10), and
setting up a connection to the second device (20) using the address (DAC) determined in the previous step.

2. The method as claimed in claim 1, characterized by the steps of:
discovering which devices (20) are available and what their addresses are in parallel with determining the address (DAC) of the second device in dependence on the present environment, and
setting up the connection to the second device (20) upon selecting it by a user using the address discovered in the discovering step.

3. The method as claimed in claim 1, characterized in that for setting up the connections the second device (20) is paged by means of the short range wireless communications module (11) of the mobile device (10) using the address determined in dependence on the present environment of the mobile device (10).

4. The method as claimed in claim 1, characterized in that the address of the second device is determined by comparing environment data according to the present environment of the mobile device (10) with environment data of devices stored in a memory (13) of the mobile device (10) together with the device address (DAC).

5. The method as claimed in claim 4, characterized In that the environment data and the device address (DAC) of the second device (20) are stored when the mobile device (10) is connected to the second device (20).

6. The method according to claim 4, characterized in that the environment data of the mobile device (10) being connected to a second device (20) is stored as environment data of the second device (20).

7. The method as claimed in claim 4, characterized in that the environment data of the second device (20) to be stored in the mobile device (10) is transmitted from the second device (20) to the mobile device (10).

8. The method as claimed in claim 4, characterized In that the environment data and the device address (DAC) of the second device (20) are transmitted and stored independently from a connection between the mobile device (10) and the second device (20).

9. The method as claimed in claim 1, characterized in that in case that only one device address (DAC) is stored together with environment data corresponding to the present environment of the mobile device (10) a connection to this device (20) is set up automatically.

10. The method as claimed in claim 1, characterized in that in case that one device address (DAC) that is stored together with environment data corresponding to the present environment of the mobile device (10) is marked as to be automatically connected to, a connection to this device (20) is set up automatically without user interaction.

11. The method as claimed in claim 1, characterized in that in case that more than one device addresses (DAC) are stored together with environment data corresponding to the present environment of the mobile device (10), a list of those devices is output to the user for selecting that second device that the user wants the mobile device to be connected to by the wireless communications module (11).

12. The method as claimed in claim 11, characterized in that the devices (20) are identified in a name format in the list output to the user.

13. (canceled)

14. The method as claimed in claim 1, characterized in that the present position of the mobile device (10) is obtained by determining the position of the mobile device (10) in a cellular radio communications network.

15. The method as claimed in claim 1, characterized in that the present position of the mobile device (10) is obtained by determining the position of the mobile device (10) by means of a satellites based positioning system, in particular by means of the global positioning system (GPS).

16. The method as claimed in claim 1, characterized in that the address of the second device is determined by calculating the device address (DAC) from the position data of the present position of the mobile device (10) using a predefined deterministic function.

17. The method as claimed in claim 1, characterized in that in the present environment of the mobile device (10) is determined by means of the current user context, wherein the user context comprises information like user name, time information, number connections to the second device at a certain time of the day or similar.

18. A mobile device for establishing a connection from said mobile device (10) to a second device (20) both provided with a short range wireless communications module (11, 21), comprising:
means for determining a present environment of the mobile device (10) determined by means of a present position of the mobile device (10),
means for determining an address (DAC) of the second device in dependence on said present environment of the mobile device (10), and
means for setting up a connection to the second device (20) using the address (DAC) determined in the previous step.

19. Mobile device as claimed in claim 18, further comprising:
means for discovering which devices (20) are available and what their addresses are in parallel with determining the address (DAC) of the second device in dependence on the present environment, and
means for setting up the connection to the second device (20) upon selecting it by a user using the address discovered in the discovering step.

20. Mobile device as claimed in claim 18, further comprising means for obtaining the present position of the mobile device (10) by determining the position of the mobile device (10) in a cellular radio communications network.

21. Mobile device as claimed in claim 17, further comprising means for obtaining the present position of the mobile device (10) by determining the position of the mobile device (10) by means of a satellites based positioning system, in particular by means of the global positioning system (GPS).

22. Mobile device as claimed in claim 17, further comprising means for determining the address of the second device by calculating the device address (DAC) from the position data of the present position of the mobile device (10) using a predefined deterministic function.

23. Mobile device as claimed in claim 17, further comprising a memory module (13) for storing environment data.
